(19) United States
(12) Patent Application Publication
(10) Pub. No.: US 2023/0365867 A1
(43) Pub. Date: Nov. 16, 2023

(54) APPARATUS AND METHOD FOR REMOVING DEBRIS AND ENTRAPPED AIR FROM BITUMEN

(71) Applicant: HOCS Projects Inc., Calgary (CA)

(72) Inventor: Mark Neville Smithdorf, Black Diamond (CA)

(73) Assignee: HOCS Projects Inc., Calgary, AB (CA)

(21) Appl. No.: 18/030,183

(22) PCT Filed: Oct. 6, 2021
(86) PCT No.: PCT/CA2021/051405

§ 371 Date: Apr. 4, 2023

Related U.S. Application Data
(60) Provisional application No. 63/087,940, filed on Oct. 6, 2020.

(51) Int. Cl. C10C 3/00; B01D 19/00; B01D 21/00; B03D 1/08

(52) U.S. Cl. CPC C10C 3/002; B01D 19/0015; B01D 21/0012; B03D 1/082; B03D 2203/006

(57) ABSTRACT

Apparatuses to remove entrapped air and debris from bitumen are provided. The apparatuses include a tank comprising a first and second compartment with a separating surface therebetween. Bitumen froth can be received in the first compartment and can flow from the first compartment to the second compartment via the separating surface along a first portion of the flow path. The debris is separated from the bitumen in the first compartment and eliminated through a disposal aperture to form intermediate bitumen. The intermediate bitumen then travels along a second portion of the flow path to the second compartment where it is heated to allow entrapped air to escape and form processed bitumen, prior to exiting from the apparatus. The apparatus is particularly suitable for removing entrapped air and debris from bitumen mined from bituminous sands. Related processes for operating the apparatuses are also provided.

### CROSS REFERENCE TO RELATED APPLICATION

This application claims the benefit of priority from U.S. Provisional Application No. 63/087,940 filed Oct. 06, 2020; the entire contents of Patent Application No. 63/087,940 are hereby incorporated by reference.

### FIELD OF THE DISCLOSURE

The present disclosure generally relates to bitumen extraction, and in particular to apparatuses and techniques for the removal of entrapped air and debris from bitumen.

### BACKGROUND

The following paragraphs are provided by way of background to the present disclosure. They are not however an admission that anything discussed therein is prior art or part of the knowledge of persons skilled in the art.

Bitumen is a dense, viscous hydrocarbon mixture that is found in natural petroleum deposits, notably in oil sands, also known as “tar sands” and “bituminous sands”. It is well known to the art that bitumen once extracted from oil sands may be upgraded into synthetic crude oil and subsequently refined to petroleum products, including gasoline, for example.

Open pit bitumen mining operations, for example, commonly initially involve mixing of mined oil sand ore with hot water in a separation tank, also known in the art as a “primary separation vessel”, also known as a “separation tank” or “floatation tank”, to prepare a slurry having a temperature of between about 50° C. and 60° C. The preparation of bitumen slurry additionally typically involves the introduction of air into the slurry as water and oil sand ore are mixed together. Mechanical agitation and aeration by bubbled air disrupts the granules of the oil sand ore, causing the bitumen to separate from the mineral particles, e.g. clays and/or sand particles. Once separated, the bitumen may come into contact with the air bubbles, which urge the bitumen droplets upward to form a bitumen-rich froth, so called because of its foamy appearance. The froth rises or “floats” in the separation tank to form a phase that is separable from a “middlings” layer, comprising residual bitumen, and suspended mineral particles, and a bottom layer (“tailings”), comprising water and coarse insoluble minerals that have settled in the tank.

By volume, froth droplets consist of about 20% liquid and solid that are transported upwards on about 80% air. Pure bitumen at 15° C. has a specific gravity (S.G.) slightly below 1.0. Therefore, bitumen poorly floats on water which has a S.G. of 1.0. The introduction of air into the bitumen causes the oil droplets to be conveyed on the bubbled air to rise to the top of the separation tank. Thus, aeration techniques are commonly employed in oil sand processing operations to recover bitumen from separation tanks.

Separation tanks frequently include a collection weir towards which the bitumen froth is conveyed in order to separate the froth from the middlings layer and bottom layer in the separation tank. However, debris, such as wood, rubber, fabric pieces, or other buoyant materials will also float together with the bitumen froth at the top of the separation tank and will be carried towards the weir in the froth stream. Some separation tanks are constructed to include a simple steel grating style filter or screen with, for example, 1″ x 4″ openings situated close to the separation tank weir to catch this debris as froth overflows at the collection weir. Due to the high viscosity of bitumen, smaller openings have been shown to be unsuccessful since recurring blockage requires frequent shutdown of the extraction process to facilitate cleaning. In order to clean this grating style filter, manual labor is generally the only practical choice to date. Thus, the accumulated debris is currently periodically removed from the grating using rakes or similar devices. The deposition rate of debris caught in the grating is unpredictable, and therefore, constant inspection is required to ensure that the frequency of system shutdown events caused by debris blockage is minimized. Furthermore, fumes from bitumen in the 50 - 60° C. hot environment at the top of the vessel makes this physical work uncomfortable for workers.

After the bitumen froth is collected from the weir, air must be stripped from the froth and the temperature must be increased to facilitate pumping of bitumen through a pipeline for further processing. Hence techniques to remove air and increase the temperature of bitumen have been developed. A first technique, for example, involves the removal of entrapped air by shear force, using a process involving sliding and tumbling of bitumen froth in thin layers down a sufficiently long sloped surface inside a vessel known in the art as an inclined plate separator (IPS). An alternative technique involves the removal of entrapped air by a thermal process in a containment vessel, known as a “deaerator”, in which distribution devices known as shed decks break up the froth into droplets. Falling froth droplets then collide with rising steam introduced from the bottom of the vessel. In this process air bubbles are heated up and burst, thereby liberating air from the froth.

The IPS technique is relatively effective and low maintenance. However, this technique does not result in an increase in bitumen temperature. The deaerator technique can marginally increase bitumen temperature, as the steam has a brief heat exchange process during the bitumen droplet’s free fall under gravity through the rising steam vapor. Furthermore, one challenge associated with the deaerator technique is that the deaerator vessel has a very erosive and corrosive environment due to the turbulent nature of the steam and froth as they flow countercurrent to each other. In addition, uneven steam distribution inside the vessel and compromised shed decks can upset the process inside the vessel. Thus, frequent maintenance of deaerators is required. Furthermore, steam vapor containing undesirable odours and fine bitumen droplets is vented to the atmosphere through the top of the vessel. On average, a deaerator can consume low pressure steam at a rate of 4 to 9 kg/s depending on the bitumen feed rate, thus resulting in a significant energy loss, and substantial vapour venting.

With respect to bitumen heating, a common practice is to inject steam directly into bitumen flowing through a pipe. This can be a very violent process due to the formation of small vapor filled cavities, a process known as cavitation, which may result in a collapse of vapor in a pipe if steam and bitumen flow are not controlled properly. Piping and steam injection equipment in this process require high maintenance because of localized excessive erosion and corrosion induced by cavitation of steam vapor. Safety to workers in the vicinity of these direct steam heaters is a significant concern in the event that a section of pipe ruptures due to damage from stream induced erosion, which results in pipe surge movement in this part of a process plant. Physical damage to existing plants is a common, re-occurring event caused by direct injection of live steam.

Thus, in particular, in view of the large volumes of bitumen produced by oil sands bitumen recovery operations — typically up to 100,000 barrels/day for a single processing train — there remain significant drawbacks associated with current oil sand processing techniques. In particular, the recovery of bitumen froth from separation tanks using techniques known to the art are insufficiently effective as a result of irregular fluxes of floating debris in the froth, the presence of entrapped air in the froth, and the low temperature of the recovered bitumen froth.

Thus, there is an ongoing need in the art for improved techniques to process mined oil sand ore and recover bitumen therefrom.

### SUMMARY

The following paragraphs are intended to introduce the reader to the more detailed description that follows and not to define or limit the claimed subject matter of the present disclosure.

In one broad aspect, the present disclosure relates to apparatuses for the removal of entrapped air and debris from bitumen. Accordingly, in one aspect, in accordance with the teachings herein, the present disclosure provides, in at least one embodiment, an apparatus for the removal of entrapped air and debris from bitumen froth, the apparatus comprising:
a tank constructed and arranged for the flow of the bitumen therethrough, the tank comprising:
   a first compartment having a bitumen inlet in fluidic communication with the exterior to receive bitumen froth therefrom, the first compartment further having a debris discharge aperture;
   a second compartment having a bitumen outlet in fluidic communication with the exterior to discharge processed bitumen thereto, the second compartment further having disposed therein an indirect heating element;
   a separating surface between the first and second compartment, the separating surface being perforated with at least one separation aperture, the at least one separation aperture being sized and shaped to permit bitumen fluidic communication therethrough but prevent the passage of the debris therethrough; and
   a bitumen flow path through the tank from the first compartment to the second compartment via the at least one separation aperture,
wherein during use various forms of bitumen flow through the tank along the bitumen flow path, with the bitumen froth containing the debris and the entrapped air traversing the bitumen inlet, the debris being separated from the bitumen froth in the first compartment to produce intermediate bitumen, and the debris being eliminated through the debris discharge aperture, the intermediate bitumen being heated in the second compartment to a temperature sufficiently high to allow the entrapped air to escape from the intermediate bitumen to produce processed bitumen and the processed bitumen is discharged through the bitumen outlet.

In at least one embodiment, in an aspect, an actuator can be disposed in the first compartment to cause the various forms of bitumen to flow along the bitumen flow path.

In at least one embodiment, in an aspect, the tank can be a generally cylindrical tank comprising:
a generally cylindrical outer side wall;
a generally cylindrical inner side wall that is contained within and spaced apart from the outer side wall, the inner side wall forming the separation surface and being perforated with a plurality of separation apertures, the first compartment being defined by the interior of the inner side walls, and the second compartment being defined by the space between the outer and inner side walls; and
top and bottom closures disposed at upper and bottom portions of the outer side wall.

In at least one embodiment, in an aspect, the actuator can be an auger disposed in the first compartment generally along a longitudinal axis of the cylindrical tank, the auger being rotatable and having a helical flight extending along the longitudinal axis of the tank generally between the top closure and the bottom closure and forming an upward helical flow path along the longitudinal axis that forms a first portion of the bitumen flow path.

In at least one embodiment, in an aspect, during use rotation of the auger can cause the bitumen froth to flow through a portion of the tank along the upward helical flow path, the bitumen froth being generally simultaneously directed in an upward direction along the flight of the auger and in an outward peripheral direction through the perforated separation surface, and the debris being generally directed in the upward direction along the flight of the auger and to the exterior of the tank through the debris discharge aperture to produce the intermediate bitumen.

In at least one embodiment, in an aspect, the apparatus can have a fixed structure that is disposed within the second compartment and shaped to provide a second portion of the bitumen flow path that is a downward flow path between the perforations and the bitumen outlet.

In at least one embodiment, in an aspect, the fixed structure can be a helically winding structure longitudinally extending throughout the tank and outwardly extending along the exterior surface of the cylindrical inner side wall and forming a generally helical flow path.

In at least one embodiment, in an aspect, the indirect heating element can be a steam filled heating coil having at least one steam inlet and at least one condensate outlet.

In at least one embodiment, in an aspect, the at least one steam inlet is disposed to traverse the top portion of the cylindrical outer side wall and the at least one condensate outlet is disposed to traverse the bottom closure.

In at least one embodiment, in an aspect, the indirect heating element can be a steam filled tubular heating coil helically winding through the second compartment on the fixed structure along the exterior surface of the cylindrical inner side wall.

In at least one embodiment, in an aspect, the indirect heating element can be a steam filled plate heating coil helically winding through the second compartment on the fixed structure along the exterior surface of the cylindrical inner side wall.

In at least one embodiment, in an aspect, the indirect heating element can comprise a plurality of heating coils, each heating coil comprising a steam inlet and a condensate outlet.

In at least one embodiment, in an aspect, the indirect heating element can comprise a plurality of heating coils or heating plates mounted on the fixed structure disposed along the exterior surface of the cylindrical inner side wall, each heating coil or heating plate being coupled with a steam inlet and a condensate outlet, each steam inlet disposed to traverse the cylindrical outer side wall at successively lower positions along the outer side wall, and each condensate outlet disposed to traverse the cylindrical outer side wall at successively lower positions along the outer side wall.

In at least one embodiment, in an aspect, the heating elements and corresponding steam inlets and condensate outlets are linearly arranged along the longitudinal extent of the tank in a non-overlapping manner.

In at least one embodiment, in an aspect, the indirect heating element can be a portion of a generally closed system extending to the exterior of the tank, the closed system comprising a first portion for steam flow and a second portion for condensate flow, the first portion for steam flow generally corresponding with the steam filled heating coil helical winding through the second compartment of the tank, and the second portion for condensate flow generally corresponding with the portion of the closed system that is disposed to the exterior of the tank.

In at least one embodiment, in an aspect, the generally closed system can further comprise a heating device for providing steam at a first temperature to enter the heating coil at the top of the cylindrical tank and the steam gradually cooling down as it descends through the heating coil towards the bottom closure of the cylindrical tank.

In at least one embodiment, in an aspect, the second compartment can comprise a vapour outlet allowing entrapped air that escaped from the intermediate bitumen to discharge from the tank to the atmosphere.

In at least one embodiment, in an aspect, the top closure can comprise the vapour outlet.

In at least one embodiment, in an aspect, the top closure can comprise the bitumen inlet.

In at least one embodiment, in an aspect, an upper portion of the outer side wall can comprise the debris discharge aperture.

In at least one embodiment, in an aspect, the second compartment can be partitioned into first and second sub-compartments separated by a sub-compartment wall, the first sub-compartment comprising the heating element and being disposed between the first compartment and the second sub-compartment, and the first and second sub-compartment being fluidically connected by an interior bitumen flow channel, the second sub-compartment comprising a flow path portion from the interior bitumen flow channel through the second sub-compartment to the bitumen outlet to the exterior of the tank, the second sub-compartment also comprising the vapour outlet for the discharge of the entrapped air that escapes from the intermediate bitumen to the atmosphere, wherein the intermediate bitumen flows from the interior bitumen flow channel along the flow path portion and is discharged through the bitumen outlet.

In at least one embodiment, in an aspect, the sub-compartment wall can be a generally cylindrical wall that is located interior to and spaced apart from the outer side wall, the second sub-compartment being defined by the space between the sub-compartment wall and the outer side wall.

In at least one embodiment, in an aspect, the vapour outlet can be located at the top portion of the second sub-compartment.

In at least one embodiment, in an aspect, the interior bitumen flow channel can be located in the bottom portion of the sub-compartment wall.

In at least one embodiment, in an aspect, the radial distance between the radially most exterior portion of the auger and the interior surface of the inner cylindrical wall can be sufficient for the auger to not contact the inner cylindrical wall during rotation, and for debris to not fall in a downward direction between the most exterior portion of the auger and the interior surface of the inner cylindrical wall.

In at least one embodiment, in an aspect, a bottom portion of the helical flight of the auger is in sufficiently close proximity of the inner surface of the bottom closure to thereby scrape the debris from the inner surface of the bottom closure.

In at least one embodiment, in an aspect, the separation apertures can be shaped to widen in an outward direction.

In another aspect, the present disclosure provides, in at least one embodiment, an apparatus for the removal of entrapped air and debris from bitumen froth, the apparatus comprising:
a cylindrical tank constructed and arranged for the flow of various forms of bitumen therethrough, the tank comprising:
   a generally cylindrical outer side wall;
   a perforated generally cylindrical inner side wall disposed within the outer side wall, the inner and outer side walls being spaced apart and defining an intermural space therebetween;
   top and bottom closures disposed at top and bottom ends of the outer side wall, respectively;
   an inlet for receiving bitumen froth from the exterior to the interior of the tank;
   an outlet for providing processed bitumen from the intermural space to the exterior of the cylindrical outer side wall; and
   a disposal aperture for disposal of debris out of the interior of the tank;
an auger disposed in the cylindrical inner side wall of the tank along a longitudinal axis of the tank, the auger being rotatable and having a helical flight extending along a longitudinal axis of the tank generally between the top and bottom closures and forming an upward helical flow path along the longitudinal axis; and
an indirect heating element disposed within the intermural space,
wherein, during use when the bitumen froth containing debris and entrapped air enters through the inlet into the interior of the tank, the auger rotates and causes the bitumen froth to flow through the tank along the upward helical flow path, the bitumen froth being generally simultaneously directed in an upward direction along the helical flight of the auger and in an outward peripheral direction through the perforated inner side wall, the debris being generally directed in the upward direction along the helical flight of the auger and to the exterior of the tank through the disposal aperture thereby producing an intermediate bitumen flow, the intermediate bitumen flow traversing through the perforated side wall and being heated by the indirect heating element to a temperature sufficiently high to allow for escape of the entrapped air therefrom to produce the processed bitumen flow which then flows through the outlet.

In another aspect, the present disclosure provides, in at least one embodiment, a process for removing debris and entrapped air from bitumen froth using the apparatus of the present disclosure, wherein the process comprises:
sending the bitumen froth through the bitumen inlet into the tank, the bitumen froth containing bitumen with the debris and the entrapped air;
rotating the actuator to cause the bitumen froth to pass from the first compartment through the separating surface to the second compartment thereby separating the debris from the bitumen in the first compartment to produce an intermediate bitumen flow;
eliminating the debris from the first compartment through the disposal aperture;
heating the intermediate bitumen flow in the second compartment to a temperature sufficiently high to allow the entrapped air to escape from the intermediate bitumen flow to produce a processed bitumen flow; and
sending the processed bitumen flow substantially free of the debris and the entrapped air through the bitumen outlet.

In at least one embodiment, in an aspect, the bitumen froth provided to the inlet can contain at least about 75% (v/v) entrapped air.

In at least one embodiment, in an aspect, the bitumen froth provided to the inlet can contain at least about 80% (v/v) entrapped air.

In one embodiment, in an aspect, the processed bitumen flow provided to the outlet can contain no more than about 10% (v/v) entrapped air.

Other features and advantages of the present disclosure will become apparent from the following detailed description. It should be understood, however, that the detailed description, while indicating preferred implementations of the present disclosure, is given by way of illustration only, since various changes and modification within the spirit and scope of the disclosure will become apparent to those of skill in the art from the detailed description.

### BRIEF DESCRIPTION OF THE DRAWINGS

The disclosure is in the hereinafter provided paragraphs described, by way of example, in relation to the attached figures. The figures provided herein are provided for a better understanding of the example embodiments and to show more clearly how the various embodiments may be carried into effect. Like numerals designate like or similar features throughout the several views possibly shown situated differently or from a different angle. Thus, by way of example only, part 232 in FIG. 2F, FIG. 2H, FIG. 2L, FIG. 3A, FIG. 3B, and FIG. 3C refers to a grating in of all these figures. The figures are not intended to limit the present disclosure.

FIG. 1A is a schematic view of an example embodiment of a process for processing bitumen ore.

FIG. 1B is a schematic view of another example embodiment of a process for processing bitumen ore.

FIG. 2A is a perspective view of an example embodiment of an apparatus for removing entrapped air and debris from bitumen froth.

FIG. 2B is a vertical cross section of an example embodiment of the apparatus for removing entrapped air and debris from bitumen froth along the plane marked 2B in FIG. 2C.

FIG. 2C is a compressed view of the embodiment of FIG. 2A showing plane 2B from which in the image in FIG. 2B is shown.

FIG. 2D is a horizontal cross section of the example embodiment of the apparatus of FIG. 2A for removing entrapped air and debris from bitumen froth along the plane marked 2D in FIG. 2E.

FIG. 2E is a compressed view of the embodiment of FIG. 2A showing plane 2D from which in the image in FIG. 2D is shown.

FIG. 2F is a vertical cross section of the example embodiment of the apparatus of FIG. 2A for removing entrapped air and debris from bitumen froth along the plane marked 2G in FIG. 2F.

FIG. 2G is a compressed view of the embodiment of FIG. 2A showing plane 2F from which in the image in FIG. 2F is shown.

FIG. 2H is a horizontal cross section of the example embodiment of the apparatus of FIG. 2A for removing entrapped air and debris from bitumen froth along the plane marked 2H in FIG. 2I.

FIG. 2I is a compressed view of the embodiment of FIG. 2A showing plane 2H from which the image in FIG. 2H is generated.

FIG. 2J is an enlarged vertical cross section view of the area marked 2J in FIG. 2B.

FIG. 2K is a perspective view of a portion of a wall of the example embodiment of FIG. 2A.

FIG. 2L is an enlarged horizontal cross-sectional view of the area marked 2L in FIG. 2H.

FIG. 3A is an enlarged cross-sectional view of the area marked 3A in FIG. 2L illustrating a portion of a debris discharge component of the example embodiment of the apparatus of FIG. 2A in a first state.

FIG. 3B illustrates the portion of the debris discharge component of FIG. 3A in a second state.

FIG. 3C illustrates the portion of the debris discharge component of FIG. 3A in a third state.

FIG. 4 is a vertical cross section of another example embodiment of an apparatus for removing entrapped air and debris from bitumen froth.

FIG. 5 is a vertical cross section of another example embodiment of an apparatus for removing entrapped air and debris from bitumen froth.

The figures together with the following detailed description make apparent to those skilled in the art how the disclosure may be implemented in practice.

### DETAILED DESCRIPTION

Various processes, systems and apparatuses will be described below to provide at least one example of at least one embodiment of the claimed subject matter. No embodiment described below limits any claimed subject matter and any claimed subject matter may cover processes, systems, or apparatuses that differ from those described below. The claimed subject matter is not limited to any process, system, or apparatuses having all of the features of processes, systems, or apparatuses described below, or to features common to multiple processes, systems, or apparatuses described below. It is possible that a process, system, or apparatuses described below is not an embodiment of any claimed subject matter. Any subject matter disclosed in processes, systems, or apparatuses described below that is not claimed in this document may be the subject matter of another protective instrument, for example, a continuing patent application, and the applicants, inventors or owners do not intend to abandon, disclaim or dedicate to the public any such subject matter by its disclosure in this document.

As used herein and in the claims, the singular forms, such as “a”, “an” and “the” include the plural reference and vice versa unless the context clearly indicates otherwise. Throughout this specification, unless otherwise indicated, the terms “comprise”, “comprises” and “comprising” are used inclusively rather than exclusively, so that a stated integer or group of integers may include one or more other non-stated integers or groups of integers. The term “or” is inclusive unless modified, for example, by the term “either”. The term “and/or” is intended to represent an inclusive or. That is “X and/or Y” is intended to mean X or Y or both X and Y, for example. As a further example, X, Y and/or Z is intended to mean X or Y or Z or any combination thereof.

When ranges are used herein for geometric dimensions, physical properties, such as molecular weight, or chemical properties, such as chemical formulae, all combinations and sub-combinations of ranges and specific embodiments therein are intended to be included. Other than in the operating examples, or where otherwise indicated, all numbers expressing quantities of ingredients or reaction conditions used herein should be understood as being modified in all instances by the term “about.” The term “about” when referring to a number or a numerical range means that the number or numerical range referred to is an approximation within experimental variability (or within statistical experimental error), and thus the number or numerical range may vary between 1% and 15% of the stated number or numerical range, as will be readily recognized by the context, if this deviation does not negate the meaning of the term it modifies. Furthermore, any range of values described herein is intended to specifically include the limiting values of the range, and any intermediate value or sub-range within the given range, and all such intermediate values and sub-ranges are individually and specifically disclosed (e.g. a range of 1 to 5 includes 1, 1.5, 2, 2.75, 3, 3.90, 4, and 5). Similarly, other terms of degree such as “substantially” and “approximately” as used herein mean a reasonable amount of deviation of the modified term such that the end result is not significantly changed. These terms of degree should be construed as including a deviation of the modified term, such as up to 15% for example, if this deviation would not negate the meaning of the term it modifies.

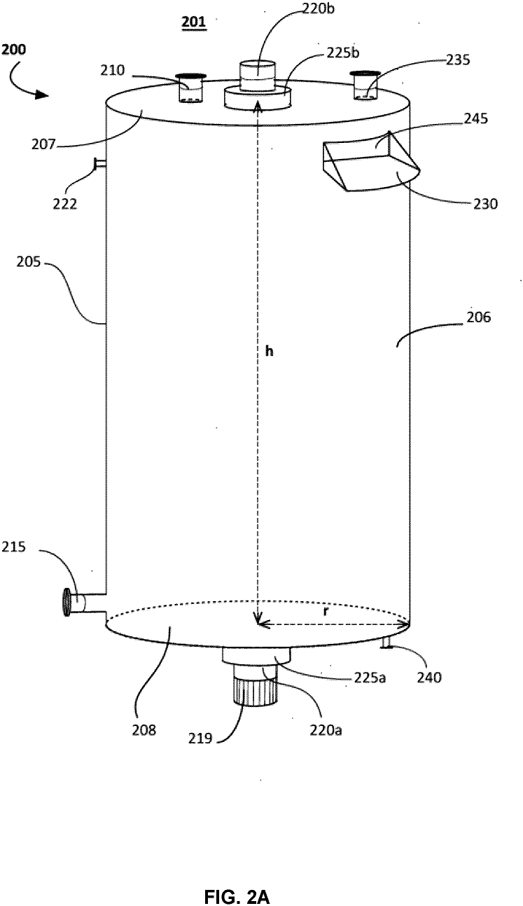

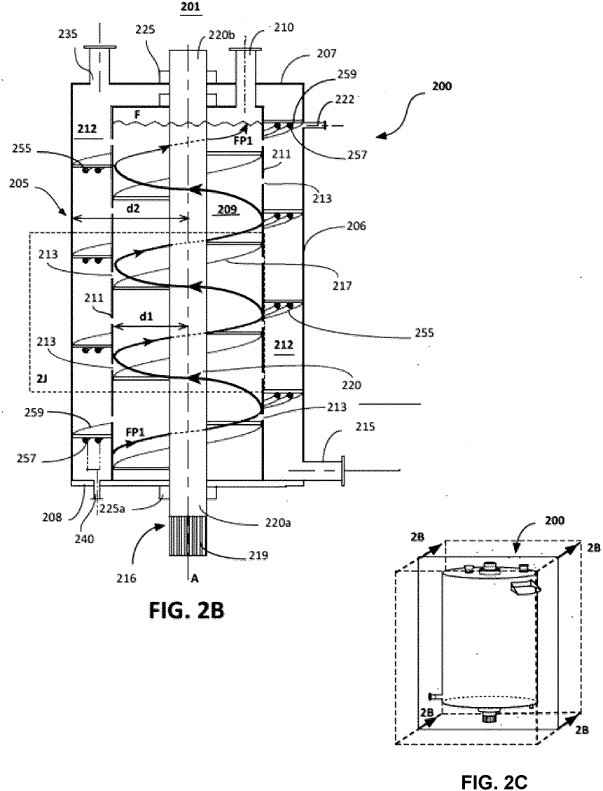

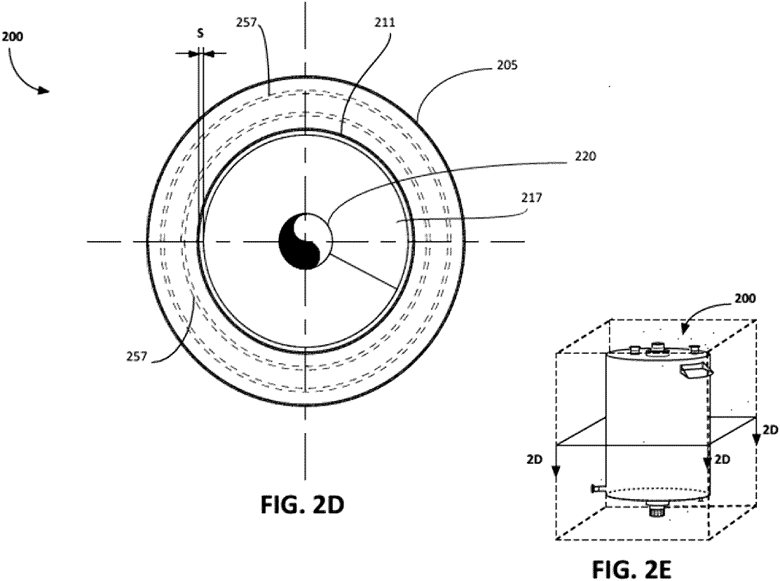

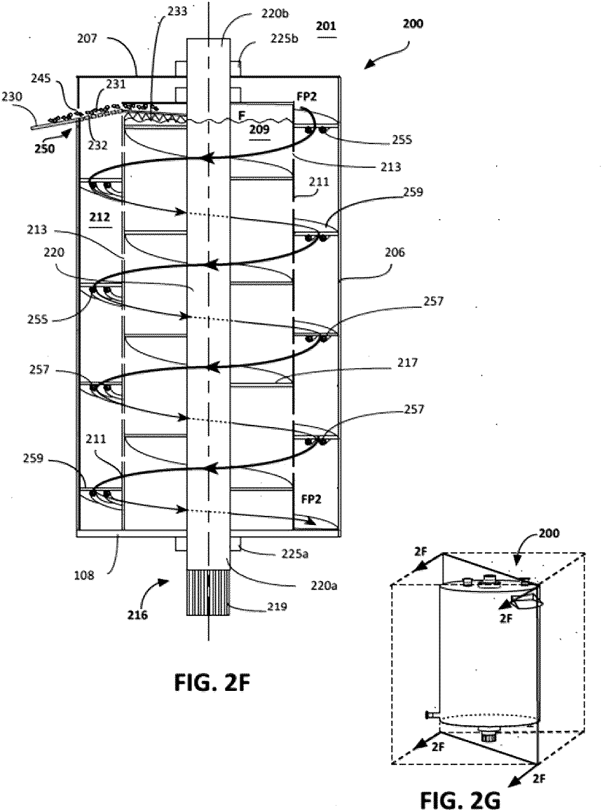

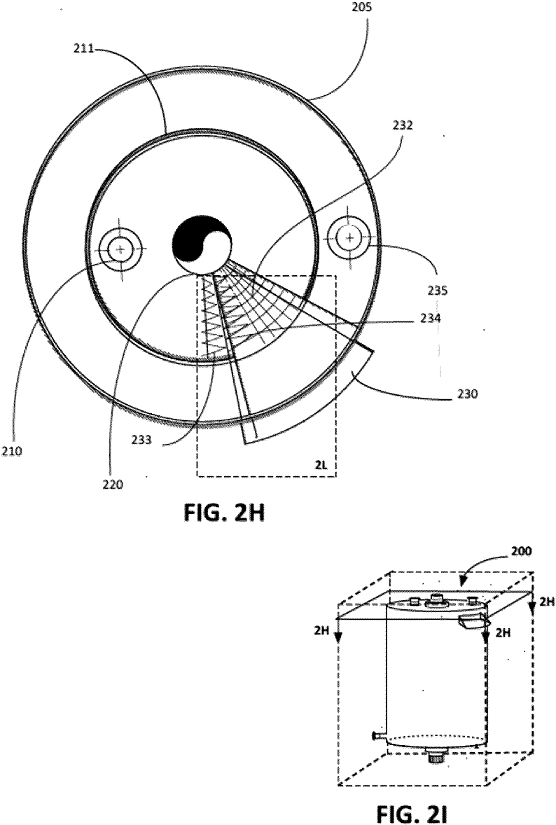

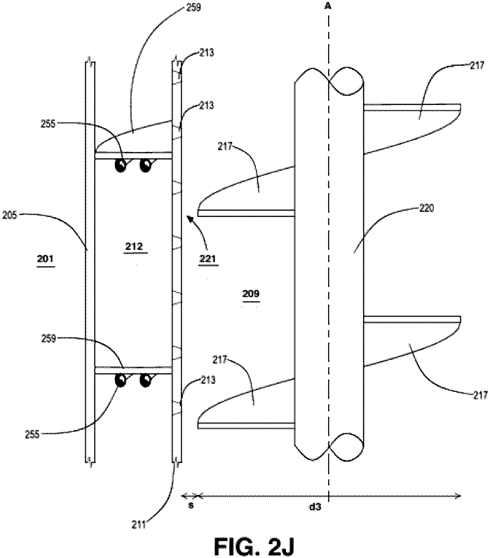

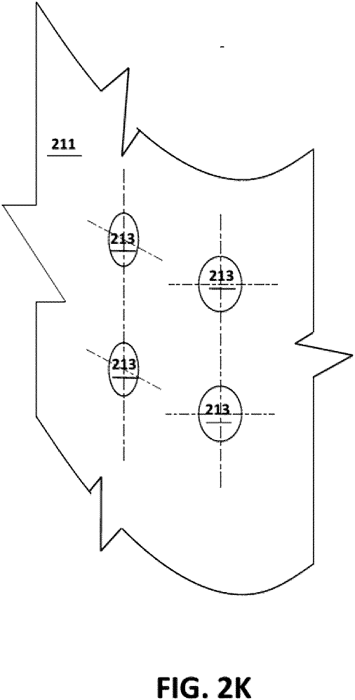

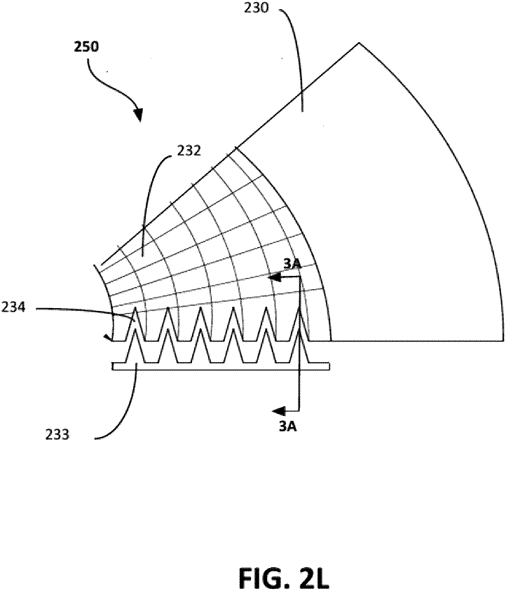

Several directional terms such as “above”, “below”, “lower”, “upper”, “inner” and “outer” are used herein for convenience including for reference to the drawings. In general, the terms “upper”, “above”, “upward” and similar terms are used to refer to an upwards direction or upper portion in relation to an apparatus for removing entrapped air and bitumen, generally positioned upright, for example, such as in the orientation shown of the apparatus in FIG. 2A. Similarly, the terms “lower”, “below”, “downward”, and “bottom” are used to refer to a downwards direction or a lower portion in relation to an apparatus for removing entrapped air and bitumen, generally positioned upright, such as in the orientation of the apparatus shown in FIG. 2A. The terms “inner” and “inward” are used herein to refer to a direction that is more radially central relative to a generally central longitudinal axis of an apparatus, such as shown in FIG. 2A, for removing entrapped air from bitumen froth, generally positioned upright, while the terms “outer” and “outward” refer to a direction that is more radially outward relative to the generally central longitudinal axis of the apparatus, such as shown in FIG. 2A.

Unless otherwise defined, scientific and technical terms used in connection with the formulations described herein shall have the meanings that are commonly understood by those of ordinary skill in the art. The terminology used herein is for the purpose of describing particular embodiments only, and is not intended to limit the scope of the presently claimed subject matter, which is defined solely by the claims.

All publications, patents, and patent applications referred to herein are herein incorporated by reference in their entirety to the same extent as if each individual publication, patent or patent application was specifically indicated to be incorporated by reference in its entirety.

In general, the various embodiments of the apparatus of the present disclosure can be used to remove entrapped air and debris from bitumen. Bitumen froth is received in the apparatus and flows through the apparatus along a bitumen flow path constructed within the apparatus. Upon removal of debris and entrapped air, processed bitumen exits from the apparatus.

In broad terms, the apparatus includes a tank comprising a first and second compartment with a separating surface therebetween. Bitumen froth can be received in the first compartment and can flow from the first compartment to the second compartment via the separating surface comprising one or more apertures along a first portion of the bitumen flow path. The debris is separated from the bitumen froth in the first compartment and eliminated through a disposal aperture to produce intermediate bitumen. The intermediate bitumen then travels along a second portion of the bitumen flow path to the second compartment where it is heated to allow entrapped air to escape thereby producing processed bitumen which then exits from the apparatus. The apparatus is particularly suitable for removing entrapped air and debris from bitumen froth that is obtained from mined bitumen from bituminous sands.

A challenge in bitumen processing operations is that following the mining of bitumen containing ore from bituminous sands and initial processing, an extracted crude bitumen product containing debris and entrapped air is obtained. In order to obtain a processed bitumen product that is suitable for pipeline transport and upgrading, debris and entrapped air must be removed from the extracted crude bitumen product. Current methods for debris removal are labour intensive due to frequent plugging and fouling of a grating that is commonly included in separation tanks known to the art, while current methods for removing entrapped air are inefficient and/or hazardous since they involve the direct heating of bitumen by direct steam injection. Furthermore, debris and entrapped air are currently removed in separate operations.

By contrast, in a first aspect, at least one embodiment of the apparatus described in accordance with the teachings herein, allows for the substantially continuous and simultaneous removal of entrapped air and debris from bitumen froth. Thus, the apparatus of the present disclosure allows for rapid and efficient processing of extracted bitumen, notably bitumen froth, and yields a bitumen product that is processed and suitable for pipeline transport. It is noted that, as used herein, the term “bitumen froth” refers to bitumen containing entrapped air. Bitumen froth further can also contain debris materials, such as wood or other fibrous plant materials, fabric, plastic, rubber and other solid, coarse non-bituminous materials which typically need removal in order to obtain a processed bitumen product suitable for pipeline transport.

Furthermore, in a second aspect, in at least one embodiment of the apparatus of the present disclosure, direct steam heating of extracted bitumen can be avoided, thus reducing mechanical damage to the processing plant due to violent, corrosive, and erosive damage associated with direct steam heating, while at the same time improving safety associated with extracted bitumen heating.

Furthermore, in a third aspect, in at least one embodiment of the apparatus of the present disclosure, the apparatus can limit steam loss to the atmosphere. Instead, steam condensate can be recovered, reheated, and reused. Thus, the apparatuses of the present disclosure are environmentally friendly, and cost-efficient to operate. Operation of such apparatuses also limit the requirement for manual labor.

Furthermore, in a fourth aspect, in at least one embodiment of the apparatus of the present disclosure, operation of the apparatus can result in a reduction of a release of steam vapor containing undesirable odours and fine bitumen droplets.

Furthermore, in a fifth aspect, in at least one embodiment of the apparatus of the present disclosure, the apparatus may be constructed and implemented in a variety of sizes. This allows for implementations in which multiple apparatuses may be operated simultaneously in parallel and/or operations which include one or more redundant back-up apparatuses. Thus, lost production expenses associated with apparatus maintenance or malfunctioning apparatuses can be mitigated.

Furthermore, in a sixth aspect, in at least one embodiment of the apparatus of the present disclosure, the apparatus may be manufactured to have dimensions that allow for road transportation of the apparatus. Thus, no substantial on-site construction and transportation of parts is required. Therefore, at least one embodiment of the apparatus can be manufactured and installed in an economical fashion.

In light of the foregoing, it can be appreciated that at least one embodiment of the apparatus of the present disclosure can address various needs in the energy sector, including the need to improve environmental friendliness of energy recovery from fossil fuel deposits and operational safety.

In what follows, selected example embodiments are described with reference to the drawings.

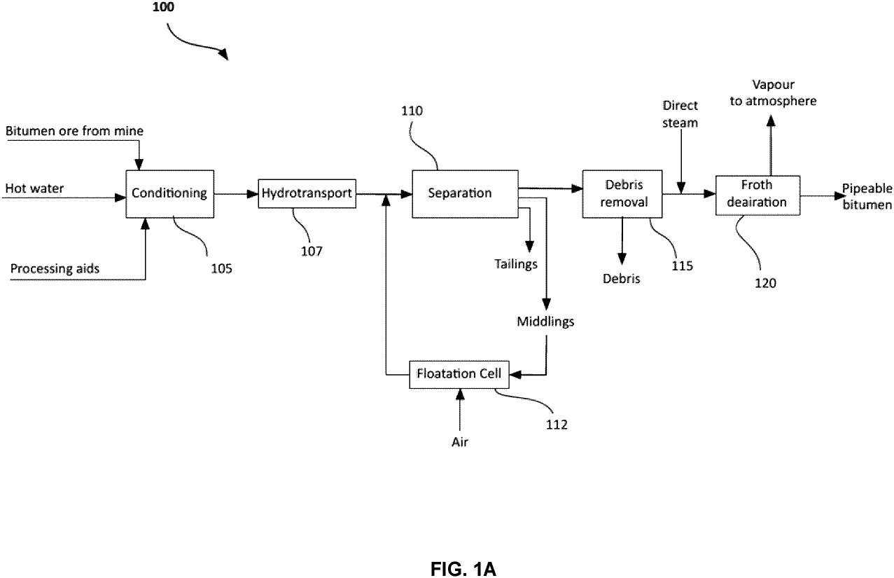

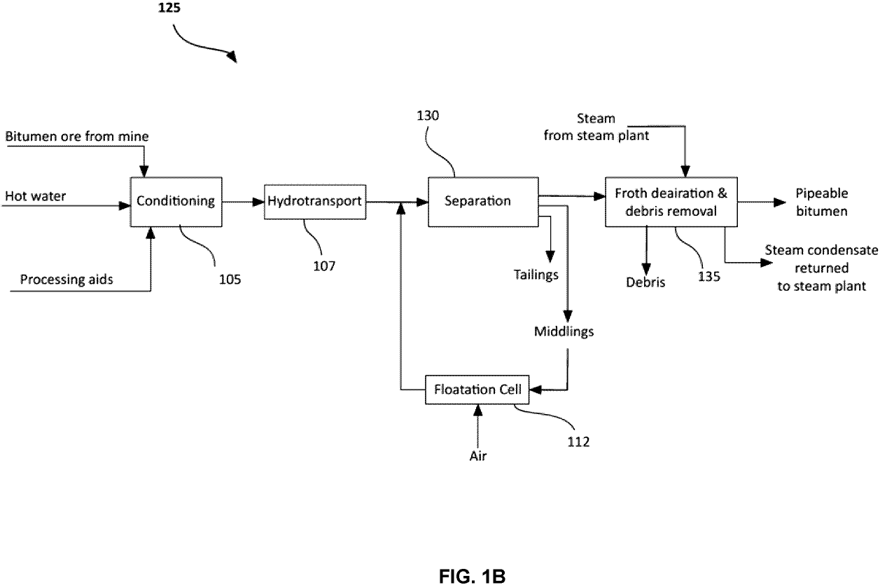

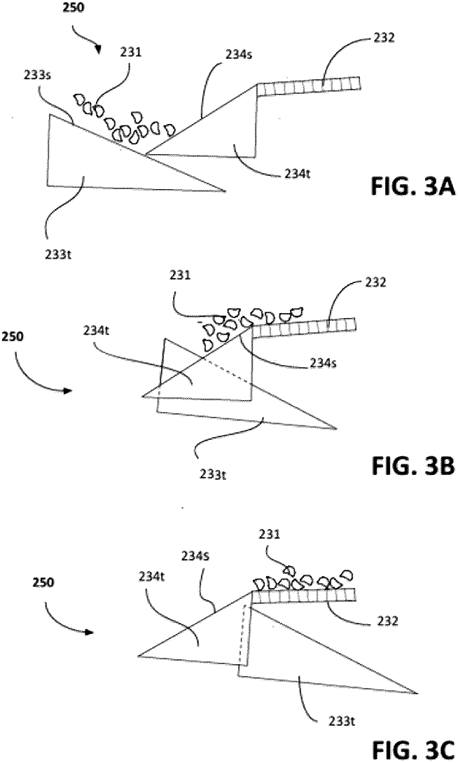

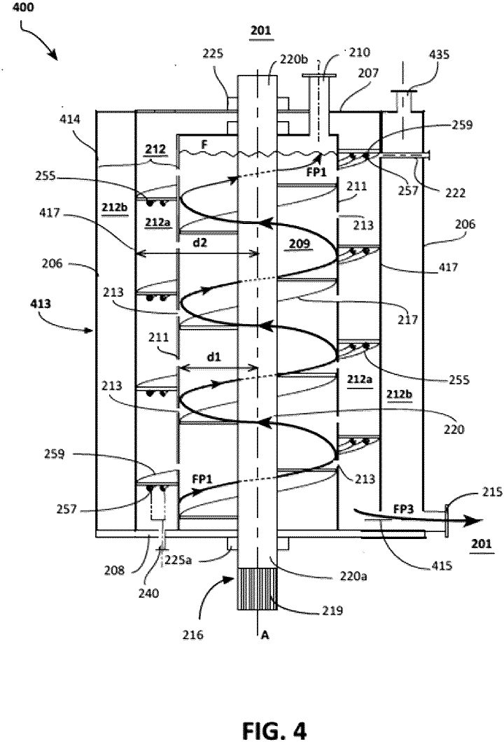

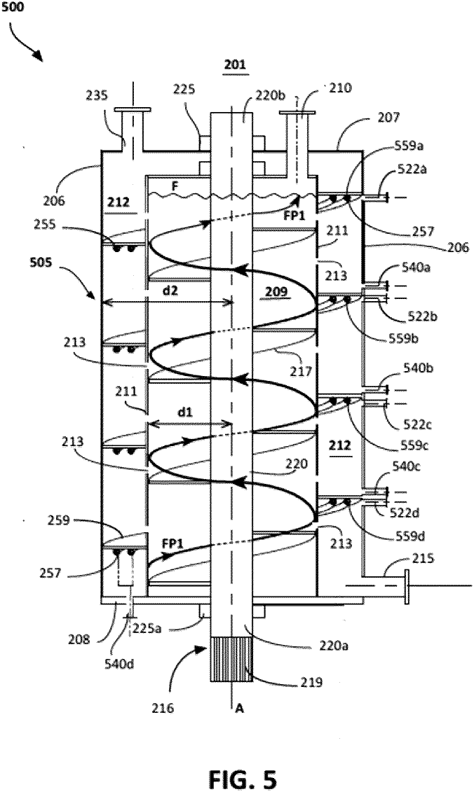

In a general overview, FIG. 1A shows a schematic view of an example standard process and system components for processing mined bitumen to yield a pipeable bitumen product. FIG. 1B shows another example process and system components for processing mined bitumen to yield a pipeable processed bitumen product according to processes of the present disclosure. FIGS. 2A - 2L show several views of an example embodiment of an apparatus 200 for removing entrapped air and debris from bitumen froth. FIGS. 3A - 3C show an example operational embodiment of a debris discharge component 250 of apparatus 200. FIGS. 4 and 5 show different embodiments of apparatuses 400 and 500, respectively, for removing entrapped air and debris from bitumen.

Referring initially to FIG. 1A, shown therein is a general example schematic illustrating a standard process 100 for processing bitumen ore to obtain a bitumen product suitable for pipeline transport, i.e. a pipeable bitumen product. In general, as used herein, the term “pipeable bitumen”, or “pipeable bitumen product” refers to a processed bitumen product containing less than 10% (w/w) of mineral solids, and from which entrapped air has been substantially removed, i.e. a bitumen product containing less than 10% or about 10% (v/v), 9% or about 9% (v/v), 8% or about 8% (v/v), 7% or about 7% (v/v), 6% or about 6% (v/v), 5% or about 5% (v/v), 4% or about 4% (v/v), 3% or about 3%(v/v), 2% or about 2%(v/v), or 1% or about 1% (v/v) entrapped air. The arrows in FIGS. 1A and 1B represent conduits that transmit various inputs and outputs through the various components of system 100.

Typically, bitumen ore is first recovered, for example, by surface mining of a bituminous sand deposit, such as in the Athabasca Region of Alberta, Canada. As is known to those of skill in the art, bitumen ore includes various constituents, many of which are not desirable for downstream bitumen upgrading and, furthermore, render the bitumen unsuitable for pipeline transport, and therefore must be removed. Thus, recovered bitumen ore may contain mineral solids in an amount of about 85% (w/w), typically mostly quartz silica sand and a smaller fraction of fine clay, water from almost 0% (w/w) to about 10% (w/w), and bitumen of about 5% (w/w) to as much as 20% (w/w). In the operation of system 100, recovered bitumen ore is conditioned in a step 105, by mixing the bitumen ore with heated water and processing aids, such as caustic, in a conditioning or slurry preparation unit. During the mixing process, mechanical agitation results in the disruption of the granules of the oil sand ore, causing the bitumen to separate from the mineral particles, e.g. clays and/or sand particles. Once separated, the bitumen may come into contact with air and form a bitumen-rich froth. The conditioned slurry in step 107 is then conveyed using a hydrotransport pipeline. During hydrotransport of the conditioned slurry, shear forces result in further breakage of larger ore lumps, the liberation of bitumen, and material homogenization. Furthermore, during hydrotransport, bitumen is further aerated. In next step 110, the homogenized slurry is separated in a separation vessel, which typically operates under somewhat quiescent conditions. In the top portion of the separation vessel, a bitumen froth layer comprising aerated bitumen is formed. In addition, in the middle portion of the separation vessel a “middling” phase, primarily containing suspended solids and residual bitumen is formed. A tailings phase, containing insoluble materials is formed in the bottom portion of the separation vessel. The middling phase, since it contains substantial quantities of residual bitumen, is recovered from the separation vessel and separately aerated in a floatation vessel such as a floatation cell (step 112) before being returned to the separation vessel for further bitumen recovery. The tailings phase is discarded from the separation vessel.

A suitable separation vessel can contain, in a typical embodiment, a weir towards which the bitumen froth is directed. The weir commonly contains a screen or grate to remove debris from the bitumen froth such as, for example, rubber chunks broken away from heavy hauler tires, fabric pieces, or other materials that are lighter than water and that float together with the bitumen froth at the top of the separation tank. The bitumen froth then overflows the weir and is collected. It is noted that the collected bitumen froth contains substantial quantities, for example, 70% or about 70% (v/v), 75% or about 75% (v/v), or 80% or about 80% (v/v), of entrapped air (injected in step 110). The collected debris is removed from the grating, for example by manual collection using a rake (step 115). The middling and sediment tailings are discarded or further treated for additional bitumen recovery. In a next step 120, the collected bitumen froth then is deaerated, typically by direct steam heating, to yield a pipeable bitumen product. Deaeration may be performed using, for example, an inclined plate separator (IPS), or, for example, a steam injection based deaerator. It is noted that as a result of steam heating, hot vapour, including steam and fine bitumen droplets, escapes to the atmosphere. The pipeable bitumen product may be transported for upgrading and used as a source material for refining a material or liquid to yield, such as for example, gasoline.

Thus, in summary, it will be clear that example process 100, illustrates a standard process for the removal of various constituents from mined bitumen ore to yield a pipeable bitumen product.

Referring next to FIG. 1B in conjunction with FIG. 1A, the processes and apparatuses of the present disclosure, in general terms, can be said to be configured to substitute certain operational aspects of example standard process 100 illustrated in FIG. 1A. In particular, as illustrated by example process 125 in FIG. 1B, following bitumen conditioning (step 105), conditioned bitumen is conveyed via hydrotransport (step 107) to a separation tank for separation (step 130). Bitumen froth can then be collected from the separation tank, provided however, that the bitumen froth can be conveyed forward for the performance of step 135 without the need for debris removal in the separation tank. Instead, in step 135, according to example process 125, the apparatus and processes of the present disclosure more or less simultaneously remove entrapped air and debris from the bitumen froth. As further described below, the apparatuses and the processes of the present disclosure, in at least one embodiment, allow for a recycling of steam, instead of steam escaping to the atmosphere. According to an embodiment of the present disclosure example process 125 can be performed using the example apparatus illustrated in FIGS. 2A-2L and example operational embodiments shown in FIGS. 3A - 3C. According to other embodiments, example process 125 can further be performed using the example apparatuses illustrated in FIGS. 4 and 5.

Initially, an example embodiment of an apparatus for removing entrapped air and debris from bitumen froth will be discussed. Thereafter example operational embodiments of the apparatus will be discussed.

Thus, referring next to FIGS. 2A - 2L, shown therein is an example embodiment of an apparatus 200 for removing entrapped air and debris from bitumen froth. Apparatus 200 includes a generally cylindrical tank 205 constructed and arranged for the flow of various forms of bitumen therethrough, including, in particular, bitumen froth, i.e. bitumen containing entrapped air, and which can further also contain debris. Other forms of bitumen that flow through the apparatus 200 generally include intermediate bitumen and processed bitumen.

Cylindrical tank 205 is constructed to have a generally cylindrical outer side wall 206, a top closure 207 and a bottom closure 208, respectively. Cylindrical tank 205 further includes bitumen inlet 210 for receiving flow of bitumen froth therethrough from an element exterior 201 of cylindrical tank 205, such as a flotation tank for example, to interior first compartment 209. Bitumen inlet 210 is disposed to fluidically connect exterior 201 with interior first compartment 209 and traverses top closure 207 for receiving bitumen, notably in the form of bitumen froth.

Cylindrical tank 205 further includes additional inlets and outlets fluidically connecting interior portions of cylindrical tank 205 with exterior 201. Thus, steam inlet 222 is disposed to traverse the top portion of side wall 206 and condensate outlet 240 is disposed to traverse bottom closure 208. A further outlet, vapour outlet 235, traverses top closure 207. Each of steam inlet 222, condensate outlet 240 and vapour outlet 235 are fluidically connecting exterior 201 with intermural space 212.

Furthermore, inner side wall 211 is perforated with a plurality of apertures 213 so that interior first compartment 209 of cylindrical tank 205 and the second compartment, i.e. intermural space 212, are fluidically connected. Inner side wall 211 has a general cylindrical shape with a smaller radius than the cylinder defined by side wall 206. Inner side wall 211 has an upper surface with an aperture that receives the bitumen inlet 210. The interior of inner side wall 211 defines the first compartment 209. Apertures 213 are generally uniformly distributed across the entire inner side wall 211, as can be seen in, for example, FIG. 2J and FIG. 2K. However, in other embodiments, the apertures may be non-uniformly distributed across the entire inner side wall 211. Furthermore, as can be seen in FIG. 2J, apertures 213 are generally conically shaped, and widen in an outward direction, to thereby prevent plugging and facilitate bitumen flow therethrough, as hereinafter described from first compartment 209 to intermural space 212. In other embodiments, apertures 213 may have a different geometry, and may be cylindrically shaped or elliptically shaped, for example, or have other geometries. Furthermore, in other embodiments, the apertures 213 may be non-equally sized. Thus, for example, apertures 213 situated in the top portion of side wall 211 may be smaller sized, while apertures 213 situated in the bottom portion of side wall 211 may be larger sized. Therefore, it can readily be appreciated that, in different embodiments, the cumulative aperture area in different embodiments may vary. In general, the aperture geometry and aperture distribution across inner side wall 211 is selected, so that a uniform bitumen flow rate through cylindrical tank 205 can be achieved, as hereinafter further described.

Cylindrical tank 205 further is constructed to include an actuator, notably auger 216 comprising longitudinally extending shank 220 and helical flight 217, extending both in radial and longitudinal directions and forming first helical flow path portion FP1 through interior space 209 along the longitudinal axis, as illustrated in FIG. 2B. Auger 216 is disposed in interior 209 of cylindrical tank 205 and shank 220 is rotatable along longitudinal axis A. Top portion 220b and bottom portion 220a, which includes cog wheel 219, of shank 220 protrude through apertures in top closure 207 and bottom closure 208, respectively. In order to rotate shank 220, a drive unit (not shown) can be connected to cog wheel 219. It is noted that in alternate embodiments, cog wheel 219 may be included in top portion 220b of shank 220, instead of in bottom portion 220a of shank 220. Auger 216 may be constructed in various ways. Thus, for example, as will be known to those of skill in the art, auger 216 may have a pitch that may be constant or variable; for example, the pitch of auger 216 may be about the same size as the diameter of auger 216 or shorter than the diameter of auger 216, for example, auger 216 be single flight or multiple flight (i.e. a single or multiple flights of helical fluting attached to the torque bar of the auger), etc. Shank 220 is further kept in place by bearing and packing 225a and 225b, installed about shank 220 to the exterior of cylindrical tank 205, and adjacent to bottom cover 208 and top cover 207, respectively. It is further noted that auger 216 has a diameter d3 so that auger 216 can freely rotate within interior first compartment 209 of cylindrical tank 205, without contacting inner side wall 211 (see: FIG. 2J). It is noted that since it can be challenging to construct a perfectly dimensioned cylindrical tank, a small space 221, is generally preferably left between auger 216′s radially most exterior portion and inner side wall 211. Thus, diameter d3 of helical flight 217 equals the diameter of cylindrical inner side wall 211 less 2 x s (see: FIG. 2J) where s is the radial distance of the small space 221. Thus, in general, the radial distance s between the radially most exterior portions of helical flight 217 of auger 216 and the interior surface of the cylindrical inner side wall 211 is sufficient for the auger 216 to not contact cylindrical inner side wall 211 during rotation, on the one hand; and, on the other hand, is sufficient for debris to not fall in a downward direction between the most exterior portion of the auger 216 and the interior surface of the inner cylindrical wall 211.

Cylindrical tank 205 further includes debris discharge component 250, as can be seen in FIG. 2F. Debris discharge component 250 includes aperture 245 disposed to traverse the exterior of outside wall 206 at about the top of helical flight 217 to dispose debris 231. A radially projecting debris launder 230 is connected to exterior of outside wall 206 around aperture 245. Debris discharge component 250 further includes grating 232, disposed upward of helical flight 217. It is noted that helical flight 217 includes at its upper distal end a plurality of generally upwardly projecting teeth 233. A matching plurality of teeth 234 are located and generally projecting downward from grating 232. The interactions between upwardly projecting teeth 233 and downwardly projecting teeth 234 will hereinafter be described with reference to FIGS. 3A-3C.

Cylindrical tank 205 further includes indirect steam heating device 255 having steam inlet 222, and condensate outlet 240 and tubular heating coils 257 through which steam can flow. Steam inlet 222 and condensate outlet 240 are each fluidically connected with intermural compartment 212. Steam heating device 255 is disposed within cylindrical tank 205 so that tubular heating coils 257 extend in a downward fashion through intermural space 212 from steam inlet 222 to condensate outlet 240. Steam heating device 255 is further attached to fixed structure 259, which is disposed within intermural space 212. Fixed structure 259 is generally a longitudinally extending outwardly disposed helical structure winding that extends throughout cylindrical tank 205 contacting both the exterior surface of interior wall 211 and the inner surface of side wall 206 and forming a generally second helical flow path portion FP2, as illustrated in FIG. 2F.

It is noted that, in other embodiments, heating devices other than a device comprising tubular heating coils may be used, including, for example, a plate heating coil. Plate heating coils are known in the art, see for example: U.S. Pat. Nos. 6,460,614 and 7,093,649. Thus, in an embodiment, a plate heating coil may be installed to extend in a downward fashion, preferably helically winding through intermural space 212 from steam inlet 222 to condensate outlet 240. In embodiments comprising a plate heating coil, the plate heating coil may be attached to fixed structure 259, or the plate heating coil may substantially form fixed structure 259.

In a further embodiment, the indirect heating element can comprise a plurality of heating coils, for example, tubular or plate heating coils, with each heating coil comprising a steam inlet and a condensate outlet. Thus, in one example embodiment, the heating element can comprise a plurality of heating coils, wherein each heating coil comprises a steam inlet and a condensate outlet, wherein each steam inlet of the plurality of heating coils is disposed incrementally lower along the cylindrical outer side wall 206, and wherein each corresponding condensate outlet is also disposed incrementally lower along the cylindrical outer side wall 206.

Thus, for example, a cylindrical tank having a height (h) of 20 m, having first and second heating elements, may be constructed. The first heating element can have a first steam inlet and a first condensate outlet. The second heating element can have a second steam inlet and a second condensate outlet. The first steam inlet can traverse cylindrical side wall 206, for example, 1.5 m below top cover 207 and the first condensate outlet can traverse the cylindrical side wall 206, for example, at 10 m below top cover 207. The second steam inlet can be traverse the cylindrical side wall 206, for example at 10 m below top cover 207 and be spaced apart from the first condensate outlet and the second condensate outlet can traverse the cylindrical side wall 206 at 19 m below top cover 207. In this example embodiment, the two separate heating elements are arranged in a coaxial linear (e.g., sequential or serial) fashion along the length of the apparatus 200 without overlap. As noted, by controlling the temperature and flow rate in the two separate heating elements, the temperature gradient from the top portion of the cylindrical tank to the bottom portion of cylindrical tank may be further controlled.

The number of heating elements may be varied in different embodiments, and different embodiments may include 1, 2, 3, 4, 5, or even more heating elements. Thus, referring now to FIG. 5, shown therein is an example apparatus 500 of the present disclosure of a tank 505, containing a plurality of heating coils 559a, 559b, 559c and 559d that are arranged in a in a coaxial linear (e.g., sequential or serial) fashion along the length of the apparatus 200 without overlap. First heating coil 559a has first steam inlet 522a and first condensate outlet 540a. Second heating coil 559b has first steam inlet 522b and first condensate outlet 540b. Third heating coil 559c has first steam inlet 522c and first condensate outlet 540c. Fourth heating coil 559d has first steam inlet 522d and first condensate outlet 540d. First, second, third and fourth steam inlets 522a, 522b, 522c, and 522d traverse cylindrical side wall 206 at successively lower positions along wall 206. Similarly, first, second, third outlets 540a, 540b, and 540c, traverse cylindrical side wall at successively lower positions along wall 206, while fourth steam outlet 540d traverses bottom closure 208. By controlling the temperature and steam flow rate in separate heating coils 559a, 559b, 559c and 559d, the temperature gradient from the top portion of cylindrical tank 505 to the bottom portion of cylindrical tank 505 may be more finely controlled, and thereby release of entrapped air may be controlled and optimized. Thus, the volume of entrapped air being released from vapour outlet 235 may be measured under various conditions, notably different steam flow rates and different steam temperatures, and these flow rates and steam temperatures may be adjusted, and optimized, as desired, for example, to obtain certain conditions at vapour outlet 235. A steam flow rate and steam temperature for each heating element 559a, 559b, 559c and 559d may be separately selected, for example, certain steam flow rates and steam temperatures may be selected which maximize the amount of entrapped air that is released from cylindrical tank 505.

Thus, to briefly recap, cylindrical tank 205 is constructed and arranged for the flow of various states of bitumen therethrough and includes a generally cylindrical outer side wall 206 and a generally cylindrical perforated inner side wall 211, together defining intermural space 212 therebetween. Inner side wall 211 also defines interior first compartment 209 therein. Cylindrical tank 205 further is constructed to include rotatable auger 216, extending both in radial and longitudinal direction and forming the first helical flow path portion FP1 through interior first compartment 209. Cylindrical tank 205 further includes fixed helical structure 259 winding within intramural space 212 throughout cylindrical tank 205 between the exterior surface of interior wall 211 and the inner surface of side wall 205 forming the second helical flow path portion FP2.

Turning now to an example operational process for the embodiment of apparatus 200, as hereinbefore noted, the apparatuses of the present disclosure can generally be used to remove entrapped air and debris from bitumen. Thus, bitumen froth containing entrapped air and debris can initially be received by example apparatus 200 via bitumen inlet 210 and enter interior first compartment 209 therethrough and contact helical flight 217. Thus, interior first compartment 209 can be filled with bitumen froth, for example to level (F) (see: FIG. 2B). Rotation of augur 216 causes bitumen froth in interior first compartment 209 to be simultaneously directed upwards along first helical flow path portion FP1 formed by helical flight 217 through interior space 209, and peripherally and radially outward from interior first compartment 209 through the plurality of apertures 213 into intermural space 212 to produce intermediate bitumen and onto fixed structure 259 which causes the intermediate bitumen to flow downward along second helical flow path portion FP2. Thus, the overall bitumen flow rate from bitumen inlet 210 to bitumen outlet 215 through tank 205 is determined by the rotational rate of augur 216 and the cumulative area of apertures 213. The bitumen flow rate may vary widely, and can, for example, range from about 50 m³/hour to about 700 m³/hour. It is noted that apertures 213 are relatively small in size, for example, round apertures having a diameter of less than about 1 cm, so that debris does not traverse from interior first compartment 209 to intermural space 212, and instead remains contained within interior first compartment 209. It is noted that debris present in bitumen froth may range in size. It will be understood that the debris sized to be larger than apertures 213 will not traverse from first compartment 209 to intermural space 212. Thus, the term “debris” as used herein in different embodiments may be debris ranging in size, but refers to debris material sized to be larger than the size of apertures 213.

As the intermediate bitumen enters from interior first compartment 209 into intermural space 212 it is heated indirectly by steam heating device 255 through tubular coil 257 located in intermural space 212. Thus, for example the temperature of the intermediate bitumen in intermural space 212 can increase in such a manner that the temperature of the processed bitumen at bitumen outlet 215 is at least about 80° C. The temperature of the intermediate bitumen higher up in intermural space 212 is generally higher than intermediate bitumen at lower levels of the intermural space 212 and at a height close to steam inlet 222 the intermediate bitumen may reach a temperature that ranges from about 90° C. up to about 94° C. Thus, the intermediate bitumen in intermural space 212 is heated and entrapped air is liberated therefrom and can escape from the intermediate bitumen through vapour outlet 235. It is noted that a temperature gradient exists along tubular heating coils 257 with steam at a first temperature entering through steam inlet 222 near an upper top end of the tubular heating coils 257, and then the steam gradually cools as it descends along tubular heating coils 257 and forms a condensate close to the distal bottom end of tubular heating coils 257, and the condensate then exits through outlet 240. Furthermore, intermediate bitumen in intermural space 212 generally moves downward by gravitational force along second helical flow path portion FP2.

In at least one embodiment, tubular heating coils 257 can be a portion of a generally closed conduit system, for example a closed tubular system, extending to the exterior 201 of cylindrical tank 205. The closed conduit system can comprise a first portion for steam flow and gradually condensing towards a second portion for condensate flow. The first portion for steam flow can generally correspond with tubular heating coils 257 winding throughout intermural space 212 in cylindrical tank 205, and the second portion for condensate flow can generally correspond with the portion of the closed tubular system that is located exterior 201 of cylindrical tank 205. After having exited from cylindrical tank 205 to exterior 201, condensate may be transported further through a third portion of the generally closed conduit system. The third portion can comprise a tubular assembly, piping, or the like (not shown) situated to the exterior 201 of cylindrical tank 205 and can be coupled to a heating device (not shown) for heating the condensate, also situated to the exterior 201 of cylindrical tank 205, to a temperature sufficiently high to form steam, which can then be directed further through the closed conduit system to enter steam inlet 222. Thus, the steam/condensate can be continuously reused, and no steam is lost to the atmosphere.

Referring now to FIG. 4, the present disclosure further includes, in at least one embodiment, an apparatus 400 comprising cylindrical tank 413 which includes a second compartment, i.e. intermural space 212 is partitioned in first and second sub-compartments 212a and 212b, each of which are generally enclosed, and separated by sub-compartment wall 417. Sub-compartment wall 417 is spaced apart from interior wall 211, and from exterior wall 206. Further, first sub-compartment 212a is disposed interior to second sub-compartment 212b, so that second sub-compartment 212b is defined by exterior wall 206 and sub-compartment wall 417, and so that first sub-compartment 212b is defined by interior wall 211 and sub-compartment wall 417. First sub-compartment 212a contains heating element 255. Furthermore, first sub-compartment 212a and second sub-compartment 212b are fluidically connected by interior bitumen flow channel 415. Second sub-compartment 212b comprises a third flow path portion (FP3) from interior bitumen flow channel 415 through second sub-compartment 212b to bitumen outlet 215 fluidically connecting second sub-compartment 212b to exterior 201 of cylindrical tank 413. Instead of vapour outlet 235 traversing top cover 207 and being fluidically connected with intermural space 212 (as illustrated in embodiment 200), second sub-compartment 212b comprises alternative vapour outlet 435 for the escape of the entrapped air to the atmosphere. Intermediate bitumen then flows from bitumen flow channel 415 along third flow path portion FP3 through second sub-compartment 212b from which entrapped air can escape through alternative vapour outlet 435, and processed bitumen can then exit to exterior 201 through bitumen outlet 415. It is noted that in apparatus 400, a larger amount of space is available in tank 413 in which entrapped air may escape from the intermediate bitumen, than in tank 205 of apparatus 200. The additional space available for the escape of entrapped air from the intermediate bitumen can further promote the release of entrapped air from the intermediate bitumen as it flows along third flow path portion FP3 thereby producing a purer form of bitumen at bitumen outlet 415. Furthermore, it is noted that in some cases in apparatus 200 local high temperatures (e.g. very close to heating coils 257 in intramural space 212, particularly in the hotter top portion of intramural space 212) may lead to local bitumen foaming in compartment 212, which in turn may result in the development of hot vapour including liquid carrying bitumen contaminant material which can escape through vapour outlet 235. In such cases, contaminant bitumen material may be introduced into the atmosphere. However, by separating intramural space 212 into sub-compartments 212a and 212b, as is the case in apparatus 400, hot vapour developing at local hot spots in sub-compartment 212a cannot readily escape therefrom. Instead, in apparatus 400, vapour can escape from sub-compartment 212a initially at the cooler bottom portion of tank 413 through bitumen flow channel 415, and then through vapour outlet 435. The cooler vapour contains less liquid and bitumen contaminant, and thus more limited quantities of bitumen material may escape to the atmosphere from vapour outlet 435.

Turning again now to FIG. 2F and the disposal of debris, as bitumen froth and debris contained therein move upwards along the first helical flow path portion FP1 formed by helical flight 217, debris, since it cannot traverse interior wall 211, is caused to move upward along first helical flow path portion FP1 of helical flight 217 towards the distal upper end of helical flight 217.

It is noted that in at least one embodiment, the bottom proximal portion of augur flight 217 is in close proximity, for example within less than about 10 cm, less than about 5 cm, or less than about 2 cm from the inner surface of the bottom enclosure 208 or may contact the inner surface of the bottom closure 208. Thus, when auger 216 rotates, debris is scraped from the inner surface of bottom closure 208 by the bottom portion of augur flight 217. Thus, such debris that initially entered through bitumen inlet 210 and was then conveyed to the bottom of interior first compartment 209, may be transported upwards through interior first compartment 209 along the entire longitudinal length of first helical flow path portion FP1, while at the same time no substantial quantities of intermediate bitumen accumulate on the inner surface of bottom closure 208.

Turning now to FIGS. 2H, 2L and 3A - 3C, rotation of auger 216 causes debris 231 to move to the top of top of helical flight 217 and up onto grating 232, and from there onto debris launder 230. Debris 231 may then be collected by a container or truck (not shown) and transported off site. It is noted that steam in intermural space 212 heats debris 231 as steam vents through grating 232. Thus, residual bitumen adhering to debris 231 on grating 232 will be further heated, liquefy and drip into intermural space 212, and add to the processed bitumen yield, and will not be part of the debris 231 via discharge component 250.

FIGS. 3A - 3C show a plurality of upwardly projecting teeth 233 with one tooth 233t labelled. Teeth 233 are attached to upper distal end of helical flight 217 of the auger 216 and mate with a plurality of downward projecting static teeth 234 with a downward projecting tooth 234t being labelled that mates with tooth 233t, as helical flight 217 of the auger 216 rotates in three different states. In the first state (FIG. 3A), as the auger 216 rotates, upward projecting tooth 233t approaches downward projecting static tooth 234t. Debris 231 has collected on the upper surface 233s of upward projecting tooth 233t. In the second state (FIG. 3B), additional rotation of helical flight 217 has resulted in upward projecting tooth 233t rotating and moving further forward and upward relative to downward projecting static tooth 234t and the teeth 233t and 234t are side-by-side. This causes debris 231 from upper surface 233s of rotating upward projecting tooth 233t to move onto upper surface 234s on downward projecting static tooth 234t. In a third state (FIG. 3C), additional helical rotation of the auger 216 results in rotating upward projecting tooth 233t moving further forward and upward relative to downward projecting static tooth 234t. This has caused transport of debris 231 from upper surface 234s of downward projecting static tooth 234t onto grating 232.

Thus, to briefly recap, bitumen product, such as bitumen froth, containing debris 231 and entrapped air can enter cylindrical tank 205 by flowing through bitumen inlet 210 and thereby enter interior compartment 209 of cylindrical tank 205. Rotation of auger 216 causes the bitumen product to flow through the tank 205 along upward first helical flow path portion FP1, the bitumen product being generally simultaneously directed in an upward direction along helical flight 217 of auger 216 and in outward peripheral direction through perforated inner side wall 211. Debris 231 is also generally directed in an upward direction along helical flight 217 and first helical flow path portion FP1 of auger 216. However, debris 231 is not directed through perforated inner side wall 211 since the debris is too large to pass through the apertures in inner side wall 211. Instead, debris 231 is conveyed to exterior 201 of cylindrical tank 205 through the disposal aperture 245. Intermediate bitumen from which debris has been removed, upon flow through perforated side wall 211 into intermural space 212, proceeds along second helical flow path portion FP2 formed by fixed structure 259 moving, by gravitational force, generally downward along the second helical flow path portion FP2. First helical flow path portion FP1 and second helical flow path portion FP2 together constitute the bitumen flow path through tank 205. Furthermore, in intermural space 212, bitumen is heated indirectly by heating element 255 to a temperature sufficiently high to reduce the viscosity of bitumen and thereby allow the escape of the entrapped air from the bitumen and up through vapour outlet 235. Processed bitumen from which entrapped air and debris has been removed and which can be said to be having a pipeable quality, can exit cylindrical tank 205 through bitumen outlet 215 at the distal bottom end of flow path portion FP2.

It will be understood by those of skill in the art that apparatus 200 may be operated in a steady state type fashion. After initially filling interior 209 with bitumen froth to reach a bitumen level F therein, the bitumen flow rate through cylindrical tank 205 may be managed such that the flow rate through bitumen inlet 210 and bitumen outlet 215 is approximately constant and equal. At such constant and equal flow rate, the fluctuation of the bitumen level F will be minimal.

It is further noted that the apparatuses of the present disclosure may be constructed in a wide variety of sizes. Thus, referring again to FIG. 2A, strictly by way of example, apparatuses may be constructed having dimensions in the range of, for example, a radius r of about 2 m and a height h of about 4 m up to, for example, a radius r of about 10 m and a height h of about 30 m, wherein, for example, h may generally vary at least from about 2 × up to about 6 × r. In some embodiments, an apparatus may be constructed to process all, or substantially all, of a bitumen froth stream from a floatation vessel in a bitumen processing operation. In another embodiment, a bitumen froth stream from a single floatation vessel may be separated into multiple bitumen froth sub streams which may then be processed by multiple apparatuses of the present disclosure. A system comprising multiple apparatuses may be advantageous since malfunctioning of a single apparatus may not require shut down of the entire processing operation. Furthermore, it may be feasible to arrange for having one or more back-up apparatuses available.

As can now be appreciated, the apparatuses and processes of the present disclosure can be used to remove debris and entrapped air from bitumen. When bitumen comprising entrapped air and debris is conveyed through the apparatuses of the present disclosure, debris is separated from the bitumen and disposed to the exterior. Furthermore, more or less simultaneously, bitumen is heated using an indirect steam heating device and entrapped air is liberated therefrom. In this manner, the apparatuses and processes of the present disclosure can be used to generate processed bitumen which is a pipeable bitumen product, and may be used for various purposes, such as refinery purposes to manufacture gasoline, for example.

Of course, the above described example embodiments of the present disclosure are intended to be illustrative only and in no way limiting. The described embodiments are susceptible to many modifications of composition, details and order of operation. The claimed subject matter, rather, is intended to encompass all such modifications within its scope, as defined by the claims, which should be given a broad interpretation consistent with the description as a whole.

1. An apparatus for the removal of entrapped air and debris from bitumen froth, the apparatus comprising:
a tank constructed and arranged for the flow of the bitumen therethrough, the tank comprising:
a first compartment having a bitumen inlet in fluidic communication with the exterior to receive bitumen froth therefrom, the first compartment further having a debris discharge aperture;
a second compartment having a bitumen outlet in fluidic communication with the exterior to discharge processed bitumen thereto, the second compartment further having disposed therein an indirect heating element;
a separating surface between the first and second compartment, the separating surface being perforated with at least one separation aperture, the at least one separation aperture being sized and shaped to permit bitumen fluidic communication therethrough but prevent the passage of the debris therethrough; and
a bitumen flow path through the tank from the first compartment to the second compartment via the at least one separation aperture,
wherein during use various forms of bitumen flow through the tank along the bitumen flow path, with bitumen froth containing the debris and the entrapped air traversing the bitumen inlet, the debris being separated from the bitumen froth in the first compartment to produce intermediate bitumen, and the debris being eliminated through the debris discharge aperture, the intermediate bitumen being heated in the second compartment to a temperature sufficiently high to allow the entrapped air to escape from the intermediate bitumen to produce processed bitumen and the processed bitumen is discharged through the bitumen outlet.

2. An apparatus according to claim 1, wherein an actuator is disposed in the first compartment to cause the various forms of bitumen to flow along the bitumen flow path.

3. An apparatus according to claim 2, wherein the tank is a generally cylindrical tank comprising:
a generally cylindrical outer side wall;
a generally cylindrical inner side wall that is contained within and spaced apart from the outer side wall, the inner side wall forming the separation surface and being perforated with a plurality of separation apertures forming perforations, the first compartment being defined by the interior of the inner side walls, and the second compartment being defined by the space between the outer and inner side walls; and
top and bottom closures disposed at upper and bottom portions of the outer side wall.

4. An apparatus according to claim 3, wherein the actuator is an auger disposed in the first compartment generally along a longitudinal axis of the cylindrical tank, the auger being rotatable and having a helical flight extending along the longitudinal axis of the tank generally between the top closure and the bottom closure and forming an upward helical flow path along the longitudinal axis that forms a first portion of the bitumen flow path.

5. An apparatus according to claim 4, wherein during use rotation of the auger causes the bitumen froth to flow through a portion of the tank along the upward helical flow path, the bitumen froth being generally simultaneously directed in an upward direction along the flight of the auger and in an outward peripheral direction through the perforated separation surface, and the debris being generally directed in the upward direction along the flight of the auger and to the exterior of the tank through the debris discharge aperture to produce the intermediate bitumen.

6. An apparatus according to claim 3, wherein the apparatus has a fixed structure that is disposed within the second compartment and shaped to provide a second portion of the bitumen flow path that is a downward flow path between the perforations and the bitumen outlet, and/or the fixed structure is a helically winding structure longitudinally extending throughout the tank and outwardly extending along the exterior surface of the cylindrical inner side wall and forming a generally helical flow path.

7. (canceled)

8. An apparatus according to claim 3, wherein the indirect heating element is a steam filled heating coil having at least one steam inlet that is disposed to traverse the top portion of the cylindrical outer side wall and at least one condensate outlet that is disposed to traverse the bottom closure.

9. (canceled)

10. An apparatus according to claim 3, wherein the indirect heating element is a steam filled tubular heating coil helically winding through the second compartment on the fixed structure disposed along the exterior surface of the cylindrical inner side wall, or
wherein the indirect heating element is a steam filled plate heating coil helically winding through the second compartment on the fixed structure disposed along the exterior surface of the cylindrical inner side wall, or
wherein the indirect heating element comprises a plurality of heating coils, each heating coil comprising a steam inlet and a condensate outlet.

11. (canceled)

12. (canceled)

13. An apparatus according to claim 3, wherein the indirect heating element comprises a plurality of heating coils or heating plates mounted on the fixed structure disposed along the exterior surface of the cylindrical inner side wall, each heating coil or heating plate being coupled with a steam inlet and a condensate outlet, each steam inlet disposed to traverse the cylindrical outer side wall at successively lower positions along the cylindrical outer side wall, and each condensate outlet disposed to traverse the cylindrical outer side wall at successively lower positions along the cylindrical outer side wall.

14. An apparatus according to claim 13, wherein the heating elements and corresponding steam inlets and condensate outlets are linearly arranged along the longitudinal extent of the tank in a non-overlapping manner.

15. An apparatus according to claim 8, wherein the indirect heating element is a portion of a generally closed system extending to the exterior of the tank, the closed system comprising a first portion for steam flow and a second portion for condensate flow, the first portion for steam flow generally corresponding with the steam filled heating coil helical winding through the second compartment of the tank, and the second portion for condensate flow generally corresponding with the portion of the closed system that is disposed to the exterior of the tank.

16. An apparatus according to claim 15, wherein the generally closed system further comprises a heating device for providing steam at a first temperature to enter the heating coil at the top of the cylindrical tank and the steam gradually cooling down as it descends through the heating coil towards the bottom closure of the cylindrical tank.

17. An apparatus according to claim 3, wherein the second compartment comprises a vapour outlet in the top closure for allowing entrapped air that escaped from the intermediate bitumen to discharge from the tank to the atmosphere.

18. (canceled)

19. An apparatus according to claim 3, wherein the top closure comprises the bitumen inlet; and/or an upper portion of the outer side wall comprises the debris discharge aperture.

20. (canceled)

21. An apparatus according to claim 3, wherein the second compartment is partitioned into first and second sub-compartments separated by a sub-compartment wall, the first sub-compartment comprising the heating element and being disposed between the first compartment and the second sub-compartment, and the first and second sub-compartments being fluidically connected by an interior bitumen flow channel, the second sub-compartment comprising a flow path portion from the interior bitumen flow channel through the second sub-compartment to the bitumen outlet to the exterior of the tank, the second sub-compartment also comprising the vapour outlet for the discharge of the entrapped air that escapes from the intermediate bitumen to the atmosphere, wherein the intermediate bitumen flows from the interior bitumen flow channel along the flow path portion and is discharged through the bitumen outlet.

22. An apparatus according to claim 21, wherein the sub-compartment wall is a generally cylindrical wall that is located interior to and spaced apart from the outer side wall, the second sub-compartment being defined by the space between the sub-compartment wall and the outer side wall.

23. An apparatus according to claim 21, wherein the vapour outlet is located at the top portion of the second sub-compartment, and/or the interior bitumen flow channel is located in the bottom portion of the sub-compartment wall.

24. (canceled)

25. An apparatus according to claim 3, wherein the radial distance between radially most exterior portion of the auger and the interior surface of the inner cylindrical wall is sufficient for the auger to not contact the inner cylindrical wall during rotation, and for debris to not fall in a downward direction between the most exterior portion of the auger and the interior surface of the inner cylindrical wall.

26. An apparatus according to claim 3, wherein a bottom portion of the helical flight of the auger is in sufficiently close proximity to the inner surface of the bottom closure to thereby scrape the debris from the inner surface of the bottom closure and/or the separation apertures are shaped to widen in an outward direction.

27. (canceled)

28. An apparatus for the removal of entrapped air and debris from bitumen, the apparatus comprising:
a cylindrical tank constructed and arranged for the flow of various forms of bitumen therethrough, the tank comprising:
a generally cylindrical outer side wall;
a perforated generally cylindrical inner side wall disposed within the outer side wall, the inner and outer side walls being spaced apart and defining an intermural space therebetween;
top and bottom closures disposed at top and bottom ends of the outer side wall, respectively;
an inlet for receiving bitumen froth from the exterior to the interior of the tank;
an outlet for providing processed bitumen from the intermural space to the exterior of the cylindrical outer side wall; and
a disposal aperture for disposal of debris out of the interior of the tank;
an auger disposed in the cylindrical inner side wall of the tank along a longitudinal axis of the tank, the auger being rotatable and having a helical flight extending along a longitudinal axis of the tank generally between the top and bottom closures and forming an upward helical flow path along the longitudinal axis; and
an indirect heating element disposed within the intermural space,
wherein, during use the bitumen froth containing debris and entrapped air enters through the inlet into the interior of the tank, the auger rotates and causes the bitumen froth to flow through the tank along the upward helical flow path, the bitumen froth being generally simultaneously directed in an upward direction along the helical flight of the auger and in an outward peripheral direction through the perforated inner side wall, the debris being generally directed in the upward direction along the helical flight of the auger and to the exterior of the tank through the disposal aperture thereby producing an intermediate bitumen flow, the intermediate bitumen flow traversing through the perforated side wall and being heated by the indirect heating element to a temperature sufficiently high to allow for escape of the entrapped air therefrom to produce the processed bitumen flow which then flows through the outlet.

29. A process for removing debris and entrapped air from bitumen froth using the apparatus defined according to claim 2, wherein the process comprises:
sending the bitumen froth through the bitumen inlet into the tank, the bitumen froth containing the debris and the entrapped air;
rotating the actuator to cause the bitumen froth to pass from the first compartment through the separating surface to the second compartment thereby separating the debris from the bitumen in the first compartment to produce an intermediate bitumen flow;
eliminating the debris from the first compartment through the disposal aperture;
heating the intermediate bitumen flow in the second compartment to a temperature sufficiently high to allow the entrapped air to escape from the intermediate bitumen flow to produce a processed bitumen flow; and
sending the processed bitumen flow substantially free of the debris and the entrapped air through the bitumen outlet.

30. (canceled)

31. (canceled)

32. (canceled)
